(19) United States
(12) Patent Application Publication
(10) Pub. No.: US 2026/0002734 A1
(43) Pub. Date: Jan. 1, 2026

(54) DRYER

(71) Applicant: GUANGDONG KANGYE ELECTRIC APPLIANCE CO., LTD., Foshan City (CN)

(72) Inventor: Fugen Huang, Foshan City (CN)

(21) Appl. No.: 19/006,401

(22) Filed: Dec. 31, 2024

(30) Foreign Application Priority Data
Jun. 28, 2024 (CN) 202421520268.3
Aug. 16, 2024 (CN) 202411127260.5
Aug. 16, 2024 (CN) 202421998186.X
Aug. 16, 2024 (CN) 202421998345.6

(51) Int. Cl. F26B 9/06; F26B 21/00; F26B 21/10; F26B 25/00

(52) U.S. Cl. CPC F26B 9/066; F26B 21/004; F26B 25/008; F26B 21/10

(57) ABSTRACT

Provided is a dryer, including a case, at least two inner tanks and air supply assemblies, where the at least two inner tanks each include a side wall member formed by sequentially connecting at least two side plates into one piece, the at least two inner tanks are each provided with an inner chamber; the two inner tanks are provided side by side or stacked in the case, and side wall members of the two inner tanks are provided at intervals so as to form a barrier structure, where the barrier structure is configured to block heat between the inner chambers of the two inner tanks.

### CROSS-REFERENCE TO RELATED APPLICATIONS

The present disclosure claims the priority to the Chinese patent application No. 202421520268.3 filed on Jun. 28, 2024 and entitled “DRYER”, the contents of which are incorporated herein by reference in entirety.

The present disclosure claims the priority to the Chinese patent application No. 202411127260.5 filed on Aug. 16, 2024 and entitled “DRYER”, the contents of which are incorporated herein by reference in entirety.

The present disclosure claims the priority to the Chinese patent application No. 202421998345.6 filed on Aug. 16, 2024 and entitled “CABINET DOOR BEARING DEVICE AND DRYER”, the contents of which are incorporated herein by reference in entirety.

The present disclosure claims the priority to the Chinese patent application No. 202421998186.X filed on Aug. 16, 2024 and entitled “VENTILATION STRUCTURE OF DRYER AND DRYER”, the contents of which are incorporated herein by reference in entirety.

### TECHNICAL FIELD

The present disclosure relates to the technical field of drying equipment, and particularly to a dryer.

### BACKGROUND ART

Driers can process a lot of food by air-drying, can make favorite snacks very simply, and thus are gradually popular with consumers. At present, in order to meet more application requirements of users, dryers are gradually developed from a single cavity to multi-cavity application; however, it is found in the multi-cavity application that different cavities have influenced temperature and tainted odor, thus reducing users' using experience.

### SUMMARY

Embodiments of the present disclosure aim at providing a dryer, which can facilitate improving a blocking effect between different cavities in the dryer, and avoid influences of influenced temperature and tainted odor between different cavities, thus improving user' using experience.

The present disclosure adopts following technical solutions for solving the above technical problems.

Solutions of the present disclosure provide a dryer, including:
a case;
at least two inner tanks, where the at least two inner tanks each include a side wall member formed by sequentially connecting at least two side plates into one piece, the at least two inner tanks are each provided with an inner chamber; the two inner tanks are provided side by side or stacked in the case, and side wall members of the two inner tanks are provided at intervals so as to form a barrier structure, where the barrier structure is configured to block heat between the inner chambers of the two inner tanks; and
air supply assemblies, provided in the case and being in one-to-one correspondence with the inner chambers, where the air supply assemblies each have an air supply end directed to the inner chambers.

In some embodiments, two side plates are provided, and the side wall members have a cross section in an “L” shape; or
three side plates are provided, and the side wall members have a cross section in a “U” shape; or
four side plates are provided, and the side wall members have a cross section in a rectangular shape.

In some embodiments, the side wall member is molded as an integrated structure; or
two adjacent side plates on the side wall member are spliced, and the two adjacent side plates are sealed at a joint therebetween.

In some embodiments, the side plates include a first side plate and a second side plate, where the first side plate and the second side plate are respectively provided at two sides of the inner chamber; and
the first side plate and the second side plate are provided with a plurality of convex ribs protruding towards the inner chambers, the plurality of convex ribs are provided at intervals in a vertical direction, and the convex ribs on the first side plate and the second side plate are corresponding to each other.

In some embodiments, the side plates include an inner side plate and an outer side plate, and a hollow interlayer is provided between the inner side plate and the outer side plate.

In some embodiments, the inner side plate and the outer side plate have different thermal conductivity coefficients.

In some embodiments, the barrier structure is an air layer; and
the case includes an outer shell, where the outer shell is provided with a plurality of vent holes, a flow space is formed between the outer shell and the inner tanks, and the flow space communicates the air layer with the vent holes.

In some embodiments, the vent holes are provided in a strip shape, and the plurality of vent holes are provided side by side on a side surface of the outer shell in a vertical direction.

In some embodiments, the case includes an upper cover plate, the side wall members have a cross section in a “U” shape, and U-shaped openings of the two side wall members are directed to the upper cover plate and are hermetically connected to the upper cover plate; and
the upper cover plate is provided with a first through hole communicating with the air layer.

In some embodiments, a sealing rubber strip is provided between the side wall members and the upper cover plate; and
the sealing rubber strip has a width corresponding to a thickness of the side plates; or the sealing rubber strip has a width corresponding to a width of the barrier structure, the sealing rubber strip is provided with a second through hole, and the second through hole is corresponding to the first through hole.

In some embodiments, the case includes a rear cover plate, a rear end of the side wall members is hermetically connected to the rear cover plate; and
the rear cover plate is provided with a third through hole communicating with the air layer.

In some embodiments, the case is provided therein with a discharge-promoting fan, where an air supply end of the discharge-promoting fan is provided towards the air layer; and
airflow enters the air layer under the action of the discharge-promoting fan, passes through the flow space and then is discharged from the vent holes.

In some embodiments, at least one barrier net is provided between the side wall members and the rear cover plate; and
the side wall members and the barrier net are hermetically connected at a joint therebetween, and the rear cover plate and the barrier net are hermetically connected at a joint therebetween.

In some embodiments, the rear cover plate is provided thereon with air guide structures in a horn shape corresponding to the air supply assemblies.

In some embodiments, a mesh density of the barrier net is uniformly arranged; or
a mesh density of the barrier net is decreased from a central area of the inner chambers to an outer edge.

In some embodiments, the air supply assemblies each include an air blower and an electric heating member, where the air blower is configured to transfer heat dissipated by the electric heating member into the inner chamber.

In some embodiments, the inner chambers are each provided with a temperature sensor configured to detect an operating temperature, and the operating temperature of the inner chambers is set to be less than 100° C.

In some embodiments, a wind shielding plate is provided between two adjacent air supply assemblies.

In some embodiments, rotational directions of the air blowers of the two adjacent air supply assemblies are provided to be opposite.

In some embodiments, the air supply assemblies are provided with at least two air blowers.

In some embodiments, the case is provided with first air control devices, where the first air control devices are in one-to-one correspondence with the air supply assemblies, and the first air control devices each include an oscillation frame and a first driver configured to drive the oscillation frame to oscillate; and the air blowers are provided on the oscillation frames.

In some embodiments, the case is provided with second air control devices, where the second air control devices are in one-to-one correspondence with the inner chambers, and the second air control devices each include a mounting frame, a plurality of air guide plates movably provided on the mounting frame, and a second driver configured to drive the air guide plates to oscillate; and the air guide plates are provided between the air blower and the inner chamber.

In some embodiments, the barrier structure is a vacuum space.

In some embodiments, the barrier structure is filled therein with a heat insulation filler.

In some embodiments, the case is provided with a lifting groove on a side surface.

In some embodiments, the case is provided with a plug receiving groove, and the plug receiving groove is provided therein with a socket structure for plugging a plug.

In some embodiments, the case is provided with a dustproof cover on a rear side.

In some embodiments, the case is provided with cabinet doors, and the number of the cabinet doors is in correspondence with the number of the inner chambers; or the at least two inner chambers share one cabinet door.

In some embodiments, the inner chambers and the cabinet doors are provided with vent gaps therebetween, and air delivered by the air supply assemblies to the inner chambers is discharged to the outside from the vent gaps; and
the vent gaps of the two adjacent inner chambers are provided to be sealed and blocked from each other.

In some embodiments, a ratio of a flow area of the vent gap to a volume of the inner chamber is:
1 mm²: 10400 mm³-1 mm²: 5200 mm³.

In some embodiments, the case is provided with a bearing portion, the cabinet doors are provided with an abutment portion, and the abutment portion can move to the bearing portion with closing of the cabinet door, so as to support the cabinet door through the bearing portion; and
the bearing portion is provided with a first fitting portion, the cabinet door is provided with a second fitting portion, and the second fitting portion can form a locking connection with the first fitting portion along with the closing of the cabinet door.

In some embodiments, one end of the bearing portion is connected to the case, and the other end is provided to protrude towards a front side surface of the case; and
the bearing portion is detachably connected to the case; or the bearing portion is integrated with the case.

In some embodiments, the first fitting portion is a locking slot provided on the bearing portion, the second fitting portion is a locking pin provided on the cabinet door, and the locking pin can be moved to extend into the locking slot; or
the first fitting portion is a locking pin provided on the bearing portion, the second fitting portion is a locking slot provided on the cabinet door, and the locking pin can be moved to extend into the locking slot.

In some embodiments, the locking pin is provided with an elastic element, and the elastic element is connected to the locking pin, and is configured to provide a pre-tightening force to the locking pin.

In some embodiments, the tail end of the locking pin is provided in a spherical shape, and an inner wall surface of the locking slot is provided as a cambered surface; and/or a front end of the bearing portion is provided with an inclined guide surface.

Compared with the prior art, the solutions of the present disclosure at least have the following beneficial effects.

In the solutions of the present disclosure, by forming the barrier structure between the side wall members of two inner tanks, the inner chambers of the two inner tanks can be blocked by the barrier structure, so that heat transmission between the two adjacent inner chambers can be reduced, the influence of influenced temperature and tainted odor between different inner chambers can be reduced and even avoided, and independence of processing food between different inner chambers can be improved, so that users can have better using experience.

### BRIEF DESCRIPTION OF DRAWINGS

In order to more clearly illustrate technical solutions of embodiments of the present disclosure, drawings that need to be used in the embodiments of the present disclosure will be briefly introduced below. It should be understood that the drawings only show some embodiments of the present disclosure, and thus should not be regarded as limitation to the scope. Those ordinary skilled in the art could also obtain other related drawings based on these drawings without using inventive efforts.

FIG. 1 is a structural schematic view of a dryer in an example of the present disclosure.

FIG. 2 is a structural schematic view of a bottom portion of a dryer in an example of the present disclosure.

FIG. 3 is a schematic diagram of forming a barrier structure in an example of the present disclosure.

FIG. 4 is a schematic diagram of forming a barrier structure in an example of the present disclosure.

FIG. 5 is a schematic diagram of forming a barrier structure in an example of the present disclosure.

FIG. 6 is a structural schematic diagram of a side wall member in an example of the present disclosure.

FIG. 7 is a schematic diagram of forming a barrier structure in an example of the present disclosure.

FIG. 8 is a schematic diagram of forming a barrier structure in an example of the present disclosure.

FIG. 9 is a structural schematic diagram of a side wall member in an example of the present disclosure.

FIG. 10 is a schematic diagram of forming a barrier structure in another example of the present disclosure.

FIG. 11 is a schematic diagram of forming a barrier structure in another example of the present disclosure.

FIG. 12 is a schematic diagram of forming a barrier structure in another example of the present disclosure.

FIG. 13 is a sectional structural schematic diagram of a side plate in an example of the present disclosure;

FIG. 14 is a schematic view of an interior structure of a dryer in an example of the present disclosure.

FIG. 15 is a structural schematic view of an inner tank assembly in an example of the present disclosure.

FIG. 16 is a structural schematic view of an inner tank assembly in an example of the present disclosure.

FIG. 17 is a schematic view of application of side wall members in an example of the present disclosure.

FIG. 18 is a structural schematic view of a side wall member in an example of the present disclosure.

FIG. 19 is a structural schematic view of a first air control device in an example of the present disclosure.

FIG. 20 is a schematic view of installation of air blowers on an oscillation frame in another example of the present disclosure.

FIG. 21 is a schematic view of installation of air blowers on an oscillation frame in another example of the present disclosure.

FIG. 22 is a schematic view of application of a second air control device in an example of the present disclosure.

FIG. 23 is a schematic view of driving air guide plates in an example of the present disclosure.

FIG. 24 is a schematic view of installation of dustproof covers in an example of the present disclosure.

FIG. 25 is a structural schematic view of a dryer in another example of the present disclosure.

FIG. 26 is a structural schematic view of an inner tank assembly in another example of the present disclosure.

FIG. 27 is a structural schematic view of an inner tank assembly in another example of the present disclosure.

FIG. 28 is an application schematic view of a barrier net in an example of the present disclosure.

FIG. 29 is a structural schematic view of a barrier net in an example of the present disclosure.

FIG. 30 is a structural schematic view of a barrier net in an example of the present disclosure.

FIG. 31 is a structural schematic view of a barrier net in an example of the present disclosure.

FIG. 32 is a front structural schematic view of a dryer in an example of the present disclosure.

FIG. 33 is a structural comparison schematic view of a cabinet door when being closed and a case in an example of the present disclosure.

FIG. 34 is a structural schematic view of a dryer in an example of the present disclosure.

FIG. 35 is a schematic view of connection between a cabinet door when being closed and a bearing portion in an example of the present disclosure.

FIG. 36 is an enlarged structural schematic view of a locking pin in an example of the present disclosure.

FIG. 37 is a structural schematic view of a bearing portion in an example of the present disclosure.

### DESCRIPTION OF REFERENCE SIGNS

1—case, 11—foot pad, 12—power cord, 13—control panel, 14—tray, 15—bracket, 16—outer shell, 161—vent hole, 162—flow space, 163—discharge-promoting fan, 164—lifting groove, 17—upper cover plate, 171—first through hole, 18—bottom side plate, 181—fourth through hole, 182—plug receiving groove, 19—rear cover plate, 191—third through hole, 192—air guide structure, 101—air hole, 102—bearing portion, 1021—locking slot, 1022—inclined guide surface;
2—inner tank, 20—inner chamber, 201—bottom plate, 21—side wall member, 211—side plate, 2111—first side plate, 2112—second side plate, 2113—inner side plate, 2114—outer side plate, 2115—hollow interlayer, 2116—bent edge, 2117—mounting hole, 22—auxiliary plate, 23—connecting plate, 24—convex rib, 241—groove, 25—inner tank assembly, 26—sealing rubber strip, 261—second through hole, 27—barrier net, 271—first barrier net, 272—second barrier net, 28—temperature sensor;
3—barrier structure, 31—air layer, 32—vacuum space, 33—heat insulation filler, 34—heat insulation coating layer;
4—air supply assembly, 41—air blower, 42—electric heating member, 43—wind shielding plate;
5—first air control device, 51—oscillation frame, 511—shaft contact, 52—first driver, 53—oscillation arm;
6—second air control device, 61—mounting frame, 62—air guide plate, 621—first gear, 622—second gear, 63—second driver;
7—dustproof cover, 71—cover body, 72—hollow area;
8—cabinet door, 81—vent gap, 82—sealing separator, 83—locking pin, 831—elastic element.

### DETAILED DESCRIPTION OF EMBODIMENTS

Below, embodiments of the present disclosure will be further described in detail in conjunction with drawings and examples. The following detailed description of the embodiments are used to exemplarily illustrate the principle of the present disclosure, but cannot be used to limit the scope of the present disclosure, that is, the present disclosure is not limited to the described embodiments.

Unless otherwise defined, all of the technical and scientific terms used in the present disclosure have the same meanings as those commonly understood by those skilled in the art to which the present disclosure belongs; the terms used herein are merely for the purpose of describing specific embodiments, but are not intended to limit the present disclosure; the terms “comprise (include)” and “have” and any variations thereof in the description, the claims and the above BRIEF DESCRIPTION OF DRAWINGS of the present disclosure are intended to cover non-exclusive inclusions.

In the description of the present disclosure, it should be noted that, unless otherwise stated, “a plurality (multiple)” means two or more; orientation or positional relationships indicated by the terms “upper”, “lower”, “left”, “right”, “inner”, “outer” and the like are merely for the purpose of describing the present disclosure and simplifying the description, and are not intended to indicate or imply that the device or element referred to must have a specific orientation, is constructed and operated in a specific orientation, and thus cannot be understood as limitation to the present disclosure. Besides, the terms “first”, “second”, “third”, and the like are merely for descriptive purpose, but should not be construed as indicating or implying relative importance. “Vertical” is not vertical in the strict sense, but is within an allowable range of error. “Parallel” is not parallel in the strict sense, but is within an allowable range of error.

Orientation words appearing in the following description all indicate directions shown in the drawings, and do not limit specific structures of the present disclosure. In the description of the present disclosure, it should also be noted that, unless otherwise specified and defined, the terms “install”, “couple”, and “connect” are to be understood broadly, and may be, for example, a fixed connection, a detachable connection, or an integral connection; it can be a direct connection or indirect connection by an intermediary. For those ordinarily skilled in the art, specific meanings of the above terms in the present disclosure could be understood according to specific circumstances.

The phrase “embodiment” referred to in the present disclosure means that specific features, structures or characteristics described in conjunction with the embodiment can be contained in at least one embodiment of the present disclosure. This phrase appearing at various positions of the description does not necessarily refer to the same embodiment, or an independent or alternative embodiment mutually exclusive of another embodiment. Those skilled in the art understand, in explicit and implicit manners, that an embodiment described in the present disclosure can be combined with other embodiments.

In the description of the embodiments of the present disclosure, the term “and/or” is merely an association relationship describing associated objects, and indicates that three relationships may exist, for example, “A and/or B” may indicate three situations: A exists alone, both A and B exist, and B exists alone. In addition, the character “/” in the present disclosure generally means that associated objects before and after the character are in an “or” relationship.

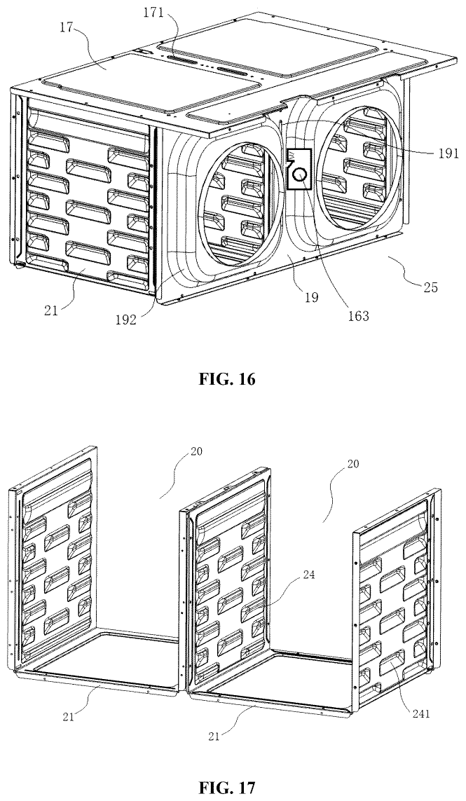

As shown in FIG. 1 to FIG. 37, solutions of the present embodiment provide a dryer, including:
a case 1;
at least two inner tanks 2, where the at least two inner tanks 2 each include a side wall member 21 formed by sequentially connecting at least two side plates 211 into one piece, the at least two inner tanks 2 are each provided with an inner chamber 20, the two inner tanks 2 are provided side by side or stacked in the case 1, and side wall members 21 of the two inner tanks 2 are provided at intervals so as to form a barrier structure 3, where the barrier structure 3 is configured to block heat between the inner chambers 20 of the two inner tanks 2; and
air supply assemblies 4, provided in the case 1 and being in one-to-one correspondence with the inner chambers 20, where air supply ends of the air supply assemblies 4 are directed to the inner chambers 20.

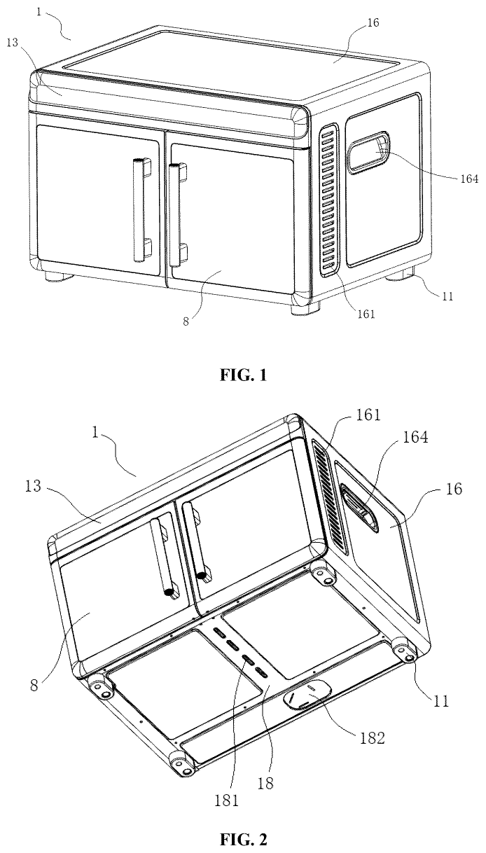

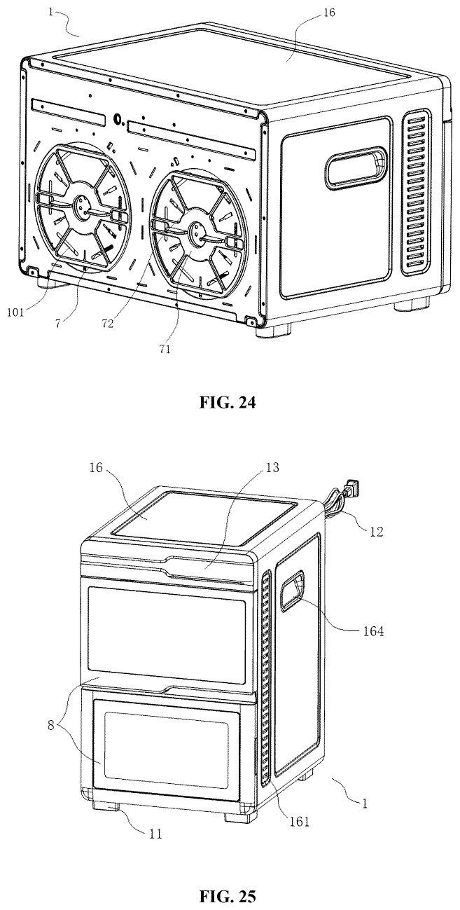

In some embodiments, as shown in FIG. 1, FIG. 2, FIG. 24, and FIG. 25, the case 1 is configured to form a frame structure of the dryer, so as to play a role in providing a support force and forming an outer contour.

In some embodiments, a plurality of foot pads 11 are provided in a bottom portion of the case 1, and the foot pads 11 enable a certain spacing distance between the case 1 and a placement plane (such as a table top, a counter surface, and a ground), so as to facilitate heat dissipation of the dryer and wiring of a power cord 12.

In some embodiments, the case 1 is provided with a control panel 13, so that the dryer can be controlled to operate through the control panel 13.

In some embodiments, the control panel 13 can be provided to include several mechanical control buttons, and the dryer is controlled to operate through the mechanical control buttons.

In some embodiments, the control panel 13 includes a mechanical control button and a display screen, and the dryer is controlled to operate through cooperation between the mechanical control button and the display screen.

In some embodiments, the control panel 13 is configured as an integrated touch screen, as shown in FIG. 1 and FIG. 25.

For specific configuration and working principle of the above control panel 13, reference can be made to the prior art, which is not specifically limited herein.

In some embodiments, the inner tanks 2 can be understood as core components of the dryer after an outer shell 16 is removed. For a single one of the inner tanks 2, it includes the inner chamber 20 and a side wall structure enclosing the inner chamber 20. Therefore, the inner tank 2 includes, but is not limited to, a literal interpretation thereof, and includes, but is not limited to, application examples described in solutions of the present embodiment.

In some embodiments, the inner tanks 2 each include the side wall member 21 and the inner chamber 20, where the inner chamber 20 is configured to temporarily store food to be processed, and the side wall member 21 serves as at least part of the side wall structure of the inner chamber 20.

In some embodiments, the two inner tanks 2 are provided side by side, as shown in FIG. 1.

In some embodiments, the two inner tanks 2 are provided to be stacked, as shown in FIG. 25.

In some embodiments, the dryer in the solutions of the present embodiment can also be used for articles such as medicinal materials and vessels that need to be processed by air-drying, which is not specifically limited herein.

In some embodiments, the air supply assemblies 4 are configured to supply air into the inner chambers 20. For example, food to be processed is placed in the inner chambers 20, and then the air supply assemblies 4 are started to process the food in the inner chambers 20 by air-drying. In the above, since at least two inner tanks 2 are provided, at least two inner chambers 20 are also provided, and as the air supply assemblies 4 and the inner chambers 20 are provided in one-to-one correspondence, by controlling a specific air supply assembly 4 to operate, food in the specific inner chamber 20 can be air-dried, so that food processing operations in different inner chambers 20 can be performed independently of each other.

As an application example therein, two side plates 211 are provided, and the side wall members 21 have a cross section in an “L” shape; or
three side plates 211 are provided, and the side wall members 21 have a cross section in a “U” shape; or
four side plates 211 are provided, and the side wall members 21 have a cross section in a rectangular (i.e., a Chinese character “ [symbol] ”) shape.

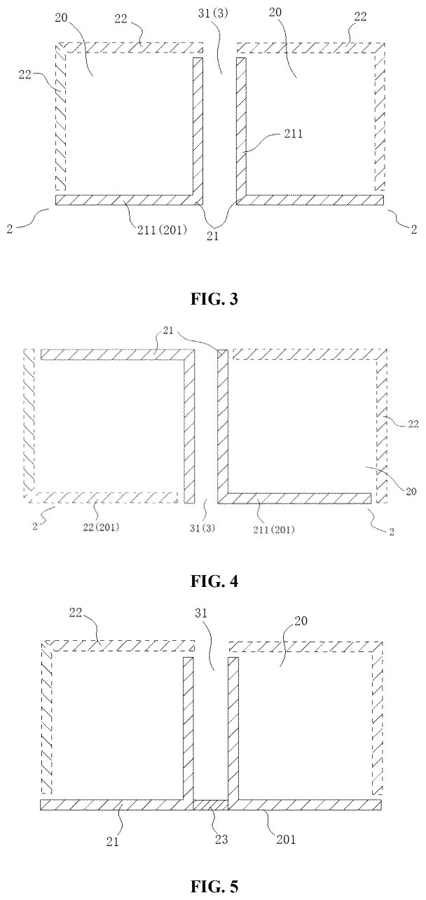

In some embodiments, as shown in FIG. 3 and FIG. 4, two side plates 211 can be provided on the side wall member 21, in which case the two side plates 211 are connected into one piece and form an “L” shape. When a cross section of the inner chambers 20 is in a rectangular shape, auxiliary plates 22 serving as the other two side surfaces need to be additionally added, and the added auxiliary plates 22 are connected to the side wall member 21 to form an enclosing side wall structure of the inner chamber 20.

In some embodiments, the auxiliary plates 22 can be an integrated member, as shown by the inner tank 2 located on the right in FIG. 3.

In some embodiments, the auxiliary plate 22 can be formed by connecting two separate plates, as shown by the inner tank 2 located on the left in FIG. 3.

In this case, a situation where the inner tanks 2 are provided side by side is taken as an example for description, and reference can be made to FIG. 3 to FIG. 6 for a method of forming the barrier structure 3.

When the inner tanks 2 are provided to be stacked, the barrier structure 3 can be formed by rotating the barrier structure 3, when the inner tank 2 is provided side by side, by 90°, which will not be repeated herein.

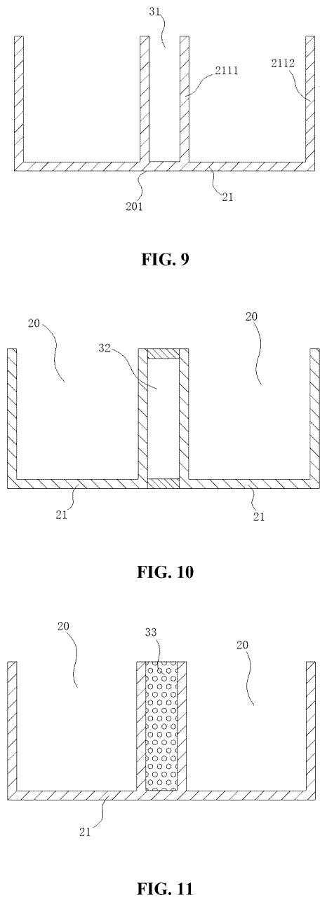

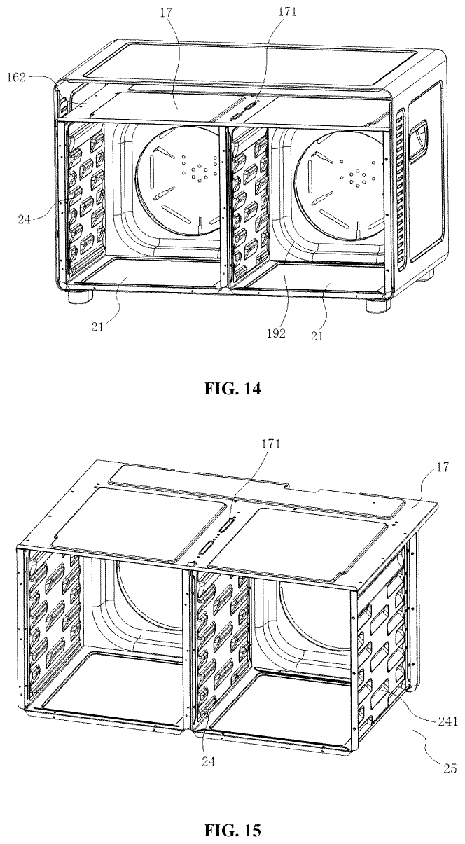

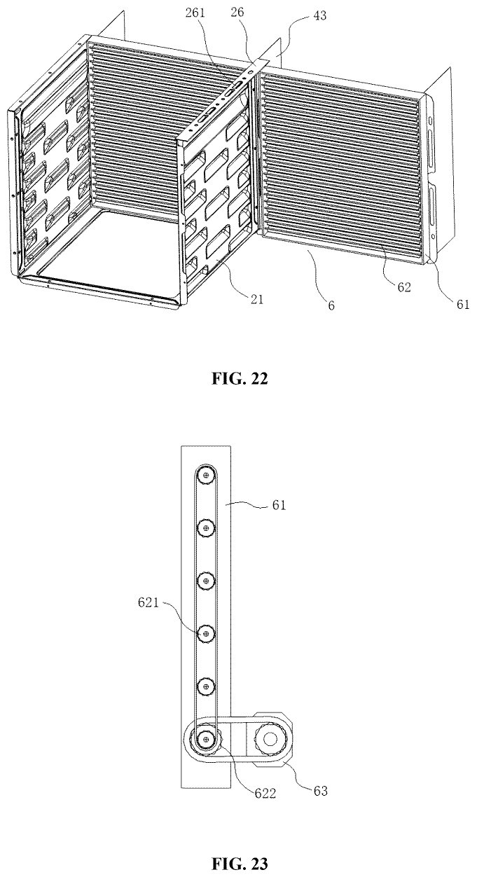

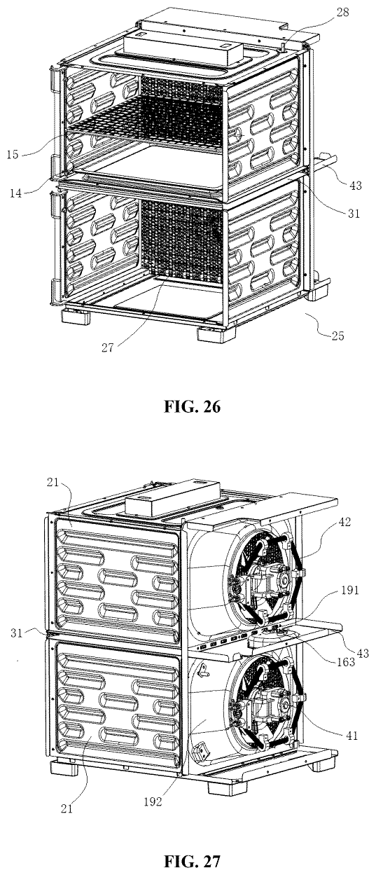

In some embodiments, as shown in FIG. 7, FIG. 8, FIG. 14 to FIG. 18, FIG. 22, and FIG. 26, three side plates 211 can be provided, and the three side plates 211 are connected into one piece and form a “U” shape. Herein, the case where the cross section of the inner chambers 20 is in a rectangular shape is still taken as an example for description, then it is feasible to add only one auxiliary plate 22, and then the auxiliary plate 22 is connected to the side wall member 21 to form an enclosing side wall structure of the inner chamber 20, as shown in FIG. 7 and FIG. 8.

In this case, a situation where the inner tanks 2 are provided side by side is taken as an example for description, and reference can be made to FIG. 7 to FIG. 12, FIG. 15, and FIG. 26 for a method of forming the barrier structure 3.

In some embodiments, four side plates 211 can be provided, in which case the four side plates 211 are connected into one piece and form a rectangular shape, that is, the cross section of the inner chambers 20 is in a rectangular shape, and the side wall member 21 serves as an enclosing side wall structure of the inner chamber 20.

In some embodiments, a situation where the inner tanks 2 are provided side by side is taken as an example for description, in which case the two side wall members 21 each takes one of the side plates 211 thereof as a bottom plate 201 of the inner tank 2, and the bottom plates 201 of the two inner tanks 2 can be connected into one piece by a connecting plate 23, as shown in FIG. 5 and FIG. 8.

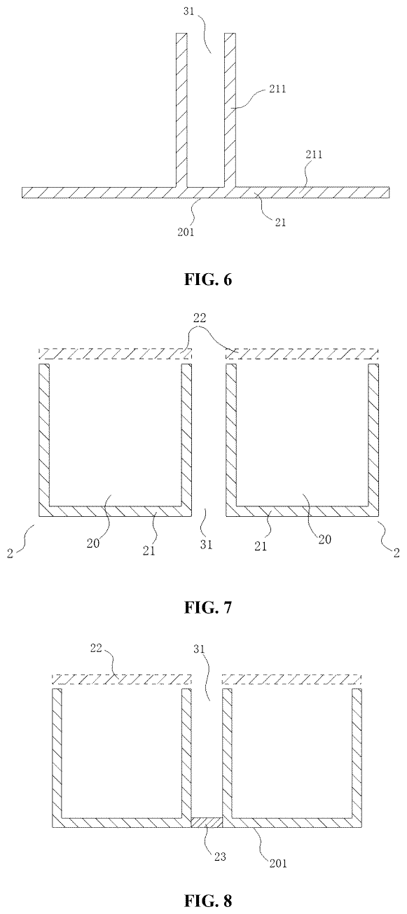

In some embodiments, the bottom plates 201 of the two inner tanks 2 are the same plate, as shown in FIG. 6 and FIG. 9.

As an application example therein, the side wall member 21 is molded as an integrated structure; or
two adjacent side plates 211 on the side wall member 21 are spliced, and the two adjacent side plates 211 are sealed at a joint therebetween.

In some embodiments, the side wall member 21 is molded as an integrated structure, for example, by bending a whole plate, liquid cast molding and other methods.

In some embodiments, the side wall member 21 is molded by splicing, in which case the side plates 211 are independent plates, and then the side plates 211 are connected to each other so as to form one piece, where the side plates 211 can be connected to each by welding sealing.

In some embodiments, the side plates 211 can be connected to each other by fasteners such as screws. When the fasteners such as the screws are used for connection, a sealing rubber pad can be provided at a joint between the side plates 211, so as to ensure a sealing effect at the joint.

In some embodiments, glue is coated at the joint between the side plates 211, so as to realize a sealed connection between the two through the glue.

As an application example therein, the side plates 211 include a first side plate 2111 and a second side plate 2112, where the first side plate 2111 and the second side plate 2112 are respectively provided at two sides of the inner chamber 20; and
the first side plate 2111 and the second side plate 2112 are provided with a plurality of convex ribs 24 protruding towards the inner chambers 20. The plurality of convex ribs 24 are provided at intervals in a vertical direction, and the convex ribs 24 on the first side plate 2111 and the second side plate 2112 are corresponding to each other.

In some embodiments, as shown in FIG. 15 and FIG. 26, each of the inner chambers 20 is provided with the first side plate 2111 and the second side plate 2112, and the first side plate 2111 and the second side plate 2112 are provided on left and right sides of the inner chamber 20, respectively.

In some embodiments, the convex ribs 24 can be molded on the first side plate 2111 and the second side plate 2112 by a stamping method, in which case the convex ribs 24 protrude towards the inner chamber 20, while back parts of the convex ribs 24 form grooves 241 on back sides of the first side plate 2111 and the second side plate 2112. Such a method of forming the convex ribs 24 not only can facilitate improving structural strength of the first side plate 2111 and the second side plate 2112, but also can facilitate reducing weights of the first side plate 2111 and the second side plate 2112.

In some embodiments, the convex ribs 24 on the first side plate 2111 and the second side plate 2112 are symmetrically provided.

In some embodiments, the convex ribs 24 on the first side plate 2111 and the second side plate 2112 have a one-to-one correspondence only in position height, while the convex ribs 24 at the same height can be set with different shapes and sizes.

The convex ribs 24 provided can play a certain role in supporting, so as to facilitate fitting with a tray 14, a bracket 15 and the like. For example, food to be processed is placed on the tray 14, and then the tray 14 is put on the convex ribs 24 on two sides, so that the food to be processed can be located in a middle position of the inner chamber 20 during processing, and a better processing effect is rendered. By providing the convex ribs 24 at intervals in the height direction, it can facilitate installation and arrangement of a plurality of trays 14 and a plurality of brackets 15 in the same inner chamber 20, and a single tray 14 can have multiple position height placement options in the inner chamber 20, as shown in FIG. 26.

As an application example therein, as shown in FIG. 13, the side plates 211 include an inner side plate 2113 and an outer side plate 2114, and a hollow interlayer 2115 is provided between the inner side plate 2113 and the outer side plate 2114.

In some embodiments, each of the side plates 211 is provided with a double-layer structure, in which case each of the side plates 211 includes the inner side plate 2113 and the outer side plate 2114, and the inner side plate 2113 and the outer side plate 2114 are hermetically connected at edges thereof, for example, sealed by welding; and the hollow interlayer 2115 is formed between the inner side plate 2113 and the outer side plate 2114. By providing the hollow interlayer 2115, heat preservation performance of the inner chambers 20 can be improved, and performance of blocking heat between two adjacent inner chambers 20 can be further improved.

As an application example therein, the inner side plate 2113 and the outer side plate 2114 have different thermal conductivity coefficients.

In some embodiments, the inner side plate 2113 and the outer side plate 2114 can be made from the same material, for example, the inner side plate 2113 and the outer side plate 2114 are both made from a metallic material, in which case the inner side plate 2113 and the outer side plate 2114 have close or the same thermal conductivity coefficient

In some embodiments, the inner side plate 2113 and the outer side plate 2114 can be made from different materials. For example, the inner side plate 2113 can be made from a metallic material, in which case the outer side plate 2114 can be made from a colloid material. For another example, the inner side plate 2113 can be made from a colloid material, and the outer side plate 2114 is made from a metallic material, in which case the inner side plate 2113 and the outer side plate 2114 have different thermal conductivity coefficients.

By selecting and designing the thermal conductivity coefficients of the inner side plate 2113 and the outer side plate 2114, the side plate 211 formed by the inner side plate 2113 and the outer side plate 2114 can have better heat insulation performance and facilitate cost control.

As an application example therein, the barrier structure 3 is an air layer 31; and
the case 1 includes an outer shell 16, where the outer shell 16 is provided with a plurality of vent holes 161, a flow space 162 is formed between the outer shell 16 and the inner tanks 2, and the flow space 162 communicates the air layer 31 with the vent holes 161.

In some embodiments, the barrier structure 3 is the air layer 31 formed by providing the two side plates 211 at intervals, for which reference can be made to FIG. 3 to FIG. 9, FIG. 15, and FIG. 26.

In some embodiments, as shown in FIG. 15 and FIG. 26, the at least two inner tanks 2, after being mounted, form an inner tank assembly 25, the case 1 includes the inner tank assembly 25 and the outer shell 16, in which case the outer shell 16 is covered on the inner tank assembly 25, so as to form the flow space 162 between the inner tank assembly 25 and the outer shell 16.

In some embodiments, as shown in FIG. 14 and FIG. 15, when the two inner tanks 2 are provided side by side, the flow space 162 is formed between left and right outer side surfaces of the inner tank assembly 25 and the outer shell 16, and between a top portion of the inner tank assembly 25 and the outer shell 16. As shown in FIG. 25 to FIG. 27, when the two inner tanks 2 are provided to be stacked, the flow space 162 can be formed between the left and right outer side surfaces of the inner tank assembly 25 and the outer shell 16. In this way, the air layer 31 can always be located in a coverage range of the flow space 162.

As an application example therein, the vent holes 161 are provided in a strip shape, and the plurality of vent holes 161 are provided side by side on a side surface of the outer shell 16 in a vertical direction.

In some embodiments, as shown in FIG. 1 and FIG. 25, the vent holes 161 are provided on left and right side surfaces of the case 1.

As an application example therein, as shown in FIG. 14 to FIG. 16, the case 1 includes an upper cover plate 17, the side wall members 21 have a cross section in a “U” shape, and U-shaped openings of the two side wall members 21 are directed to the upper cover plate 17 and are hermetically connected to the upper cover plate 17; and
the upper cover plate 17 is provided with a first through hole 171 communicating with the air layer 31.

In some embodiments, the side wall members 21 have the cross section provided in the “U” shape, and then the inner tanks 2 are formed by connecting the side wall members 21 and the upper cover plate 17, in which case inner side surfaces of three side plates of each side wall member 21 and an inner side surface of the upper cover plate 17 together serve as the side wall structure of the inner chamber 20. After the two side wall members 21 are connected with the upper cover plate 17, the inner tank assembly 25 can be formed, as shown in FIG. 15.

By providing one upper cover plate 17, and mounting the side wall members 21 on the upper cover plate 17 so as to form the inner tank assembly 25, the upper cover plate 17 can serve as a constituent member of the inner chambers 20, so as to reduce an amount of materials used for the side wall members 21, and meanwhile can also serve as a top side surface of the inner tank assembly 25, so as to improve structural strength of the inner tank assembly 25, and improve stability of the inner chambers 20 in applications.

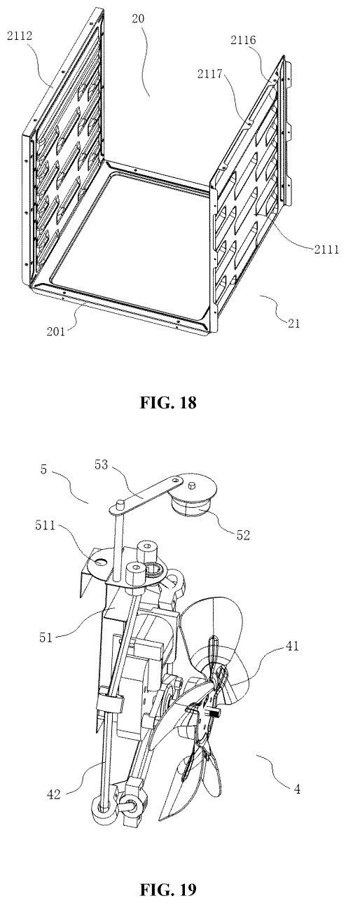

In some embodiments, as shown in FIG. 17, FIG. 18, and FIG. 22, bent edges 2116 are provided at ends of the first side plate 2111 and the second side plate 2112, and part of the bent edges 2116 is provided with mounting holes 2117; and the two inner chambers 20 can be connected with each other by passing fasteners such as bolts through the mounting holes 2117.

In some embodiments, through the connection between the bent edges of the first side plate 2111 and the second side plate 2112 and the upper cover plate 17, installation of the side wall members 21 and formation of the air layer 31 can also be realized. In this case, the upper cover plate communicates with the air layer through the first through hole provided thereon.

As an application example therein, as shown in FIG. 22, a sealing rubber strip 26 is provided between the side wall members 21 and the upper cover plate 17; and
the sealing rubber strip 26 has a width corresponding to a thickness of the side plates 211; or the sealing rubber strip 26 has a width corresponding to a width of the barrier structure 3, the sealing rubber strip 26 is provided with a second through hole 261, and the second through hole 261 is corresponding to the first through hole 171.

In some embodiments, the sealing rubber strip 26 is designed corresponding to a width of the bent edges 2116 on the first side plate 2111 and the second side plate 2112, respectively, in which case it is possible to provide the first through hole 171 only on the upper cover plate 17, and the air layer 31 communicates with the outside directly through the first through hole 171.

In some embodiments, the sealing rubber strip 26 can also be designed corresponding to a width of the air layer 31, so that after a single sealing rubber strip 26 is installed, sealing between the side plates 211 located on two sides of the air layer 31 and the upper cover plate 17 can be simultaneously realized, as shown in FIG. 22; and in this case, the second through hole 261 is provided on the sealing rubber strip 26, and the air layer 31 communicates with the outside through the second through hole 261 and the first through hole 171 in sequence.

By providing the air layer 31, the two adjacent inner chambers 20 can be conveniently blocked, so as to avoid influence of temperature in one inner chamber 20 on temperature in the other inner chamber 20, that is, to avoid a phenomenon of influenced temperature; and in this case, a temperature transmitted will spread out into the air layer 31, and by communicating the air layer 31 with the outside, it can facilitate dissipation of heat in the air layer 31.

In some embodiments, as shown in FIG. 2, the case 1 includes a bottom side plate 18, the bottom side plate 18 is provided with several fourth through holes 181, and the fourth through holes 181 communicate with the air layer 31. In this case, the heat in the air layer 31 can be directly dissipated to the outside from the fourth through holes 181.

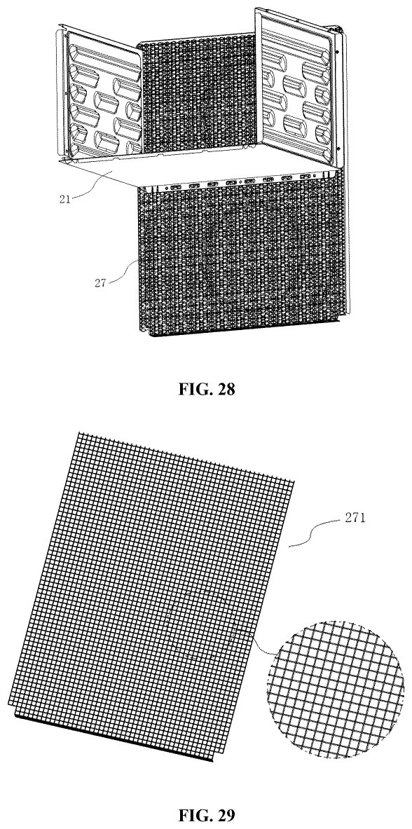

As an application example therein, as shown in FIG. 28, the case 1 includes a rear cover plate 19, a rear end of the side wall members 21 is hermetically connected to the rear cover plate 19; and
the rear cover plate 19 is provided with third through holes 191 communicating with the air layer 31.

As an application example therein, the case 1 is provided therein with a discharge-promoting fan 163, where an air supply end of the discharge-promoting fan 163 is provided towards the air layer 31; and
airflow enters the air layer 31 under the action of the discharge-promoting fan 163, passes through the flow space 162 and then is discharged from the vent holes 161.

In some embodiments, the discharge-promoting fan 163 is provided at a rear side of the rear cover plate 19, and the air supply end of the discharge-promoting fan 163 is provided towards the third through holes 191, so that the airflow can be input into the air layer 31 from the third through holes 191, and then output from the flow space 162 and the vent holes 161, so as to improve controllability of temperature in the air layer 31.

In some embodiments, the discharge-prompting fan 163 can be configured in an air blowing mode or in an air suction mode. When the air blowing mode is configured, the discharge-promoting fan 163 is provided at the rear side of the rear cover plate 19; and when the air suction mode is configured, the discharge-prompting fan 163 can be provided in the flow space 162.

As an application example therein, as shown in FIG. 28, at least one barrier net 27 is provided between the side wall members 21 and the rear cover plate 19; and
the side wall members 21 and the barrier net 27 are hermetically connected at a joint therebetween, and the rear cover plate 19 and the barrier net 27 are hermetically connected at a joint therebetween.

By providing the barrier net 27, a safety protection degree of the dryer can be improved, for example, users can be prevented from accidentally touching the air supply assembly 4 located at a rear end of the dryer in use, thereby avoiding accidental injury to the users.

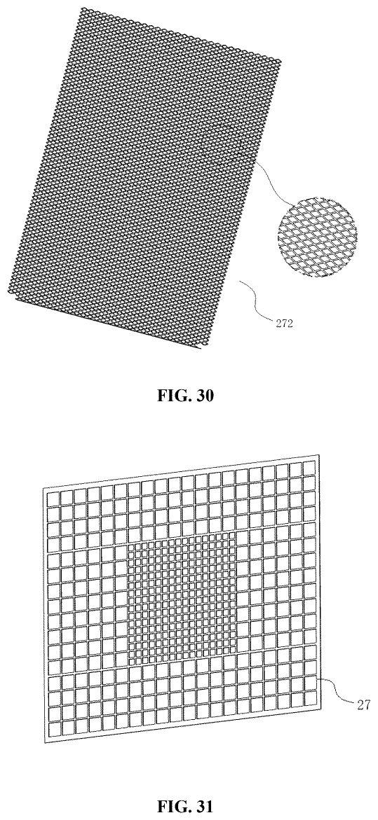

In some embodiments, as shown in FIG. 28, the barrier net 27 includes a first barrier net 271 and a second barrier net 272, where the first barrier net 271 and the second barrier net 272 are provided to be stacked. In the above, the first barrier net 271 and the second barrier net 272 can be provided with the same or different meshes; for example, the meshes of the first barrier net 271 are provided in a square shape, as shown in FIG. 29; and then the meshes of the second barrier net 272 are provided in a diamond shape, as shown in FIG. 30.

In some embodiments, the two inner chambers 20 use the same barrier net 27. The two adjacent inner chambers 20 are sealed and blocked by the barrier net 27, so that overall structural strength of the inner tank assembly 25 can be improved, and meanwhile, in cooperation with configuration of the third through holes 191, transmission of heat on the barrier net 27 can be reduced, which is more ingenious in design.

As an application example therein, the rear cover plate 19 is provided thereon with air guide structures 192 in a horn shape corresponding to the air supply assemblies 4.

In some embodiments, the air supply assembly 4 is provided at a narrow end of the horn shape of each air guide structure 192, a flared end of the horn shape of the air guide structure 192 is provided towards the inner chamber 20, and a shape of the flared end of the air guide structure 192 is adapted to a shape of a cross section of the inner chamber 20 corresponding thereto.

By providing the air guide structures 192, uniformity of air supply of the air supply assemblies 4 can be improved, so that food can be subjected to a more uniform air-drying effect in the inner chambers 20, thus improving food preparation quality and also facilitating reduction of energy consumption.

As an application example therein, a mesh density of the barrier net 27 is uniformly arranged; or
the mesh density of the barrier net 27 is decreased from a central area of the inner chambers 20 to an outer edge.

In some embodiments, as shown in FIG. 29 and FIG. 30, the barrier net 27 can be provided with a uniform mesh density, for example, each mesh is provided in a polygonal shape with a consistent size; especially when being equipped with the air guide structures 192, a mesh structure of the barrier net 27 will not have too much influence on the uniformity of air supply.

In some embodiments, as shown in FIG. 31, the mesh density of the barrier net 27 can be provided to be decreased from the central area of the inner chambers 20 to the outer edge. This structural form in applications not only can play a protective effect so as to prevent the users from directly touching the air supply assemblies 4, but also can meanwhile reduce influence of inconsistent food processing degrees brought about centralized action of the airflow output by the air supply assemblies 4 on the central area of the inner chambers 20.

As an application example therein, as shown in FIG. 19 and FIG. 27, the air supply assemblies 4 each include an air blower 41 and an electric heating member 42, where the air blower 41 is configured to transfer heat dissipated by the electric heating member 42 into the inner chamber.

In some embodiments, as shown in FIG. 27, a front side of the air blower 41 is provided towards the inner chamber 20, the electric heating member 42 is provided at a rear side of the air blower 41, and the air blower 41 is provided on the rear cover plate 19.

In some embodiments, the electric heating member 42 can be provided in an application form such as an electric heating wire, or an electric heating tube.

As an application example therein, the inner chambers 20 are each provided with a temperature sensor 28 configured to detect an operating temperature, and the operating temperature of the inner chambers 20 is set to be less than 100° C.

In some embodiments, each of the inner chambers 20 is provided with the temperature sensor 28, so as to detect and feed back the operating temperature of the inner chamber 20 through the temperature sensor 27.

In some embodiments, the operating temperature of the inner chambers 20 is controlled to be less than 100° C., and such temperature control can improve air-drying quality of food and improve taste.

As an application example therein, a wind shielding plate 43 is provided between two adjacent air supply assemblies 4.

In some embodiments, the wind shielding plate 43 is installed and provided on the rear cover plate 19, so as to block the two adjacent air supply assemblies 4, thus avoiding the phenomenon of influenced temperature between the two adjacent air supply assemblies 4.

In some embodiments, two wind shielding plates 43 are provided, and the discharge-promoting fan 163 is provided between the two wind shielding plates 43.

As an application example therein, rotational directions of the air blowers 41 of the two adjacent air supply assemblies 4 are provided to be opposite. Herein, a case where two air blowers 41 are provided is taken as an example for description, and an operator stands in front of the dryer:
in some embodiments, when the two inner chambers 20 are provided side by side in a horizontal direction, the air blower 41 located on a left side can be configured to rotate counterclockwise, and the air blower 41 located on a right side can be configured to rotate clockwise; and
in some embodiments, when the two inner chambers 20 are provided to be stacked in a vertical direction, the air blower 41 located at an upper side can be configured to rotate counterclockwise, and the air blower 41 located at a lower side can be configured to rotate clockwise.

By designing the rotational directions of the air blowers 41, when the air blowers 41 output hot airflows, main flowing directions of the hot airflows face back to the air layer 31 between the two inner chambers 20, so that rapid temperature elevation caused by direct impact of the hot airflows on the air layer 31 can be avoided. Moreover, by providing the rotational directions of the two adjacent air blowers 41 to be opposite to each other, vibration amplitude and running noise during equipment running can also be effectively reduced.

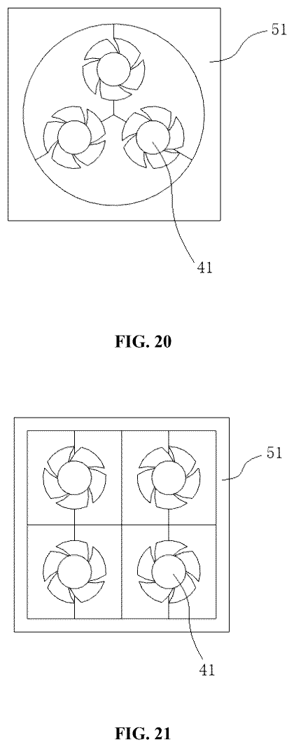

As an application example therein, as shown in FIG. 20 and FIG. 21, the air supply assembly 4 is provided with at least two air blowers 41.

In some embodiments, as shown in FIG. 20, the same air supply assembly 4 is provided with three air blowers 41, and the three air blowers 41 are provided in an equilateral triangle.

In some embodiments, as shown in FIG. 21, the same air supply assembly 4 is provided with four air blowers 41, and the four air blowers 41 are provided in a matrix.

However, in practical applications, the number of the air blowers 41 to be provided can be selected according to a volume of the inner chambers 20 and a size and power of the air blowers 41, which is not specifically limited herein.

As an application example therein, as shown in FIG. 19, the case 1 is provided with first air control devices 5, where the first air control devices 5 are in one-to-one correspondence with the air supply assemblies 4, and the first air control devices 5 each include an oscillation frame 51 and a first driver 52 configured to drive the oscillation frame 51 to oscillate; and the air blowers 41 are provided on the oscillation frames 51.

In some embodiments, the oscillation frames 51 can be rotatably mounted on the case 1 around a shaft contact 511, and the air blowers 41 of the air supply assemblies 4 are mounted on the oscillation frames 51, so that the air blowers 41 can oscillate along with rotation of the oscillation frames 51, and an oscillating motion of the air blowers 41 can just be realized.

In some embodiments, the first driver 52 is provided as a first motor, in which case the first motor is in transmission connection with the oscillation frame 51 through an oscillation arm 53, so that by controlling driving of the first motor, an oscillation movement of the oscillation frame 51 can be controlled.

By providing the first air control devices 5, the oscillating motion of the air blowers 41 of the air supply assemblies 4 can be realized, so as to realize multi-angle air supply of the air blowers 41 in the inner chambers 20, and improve the air-drying preparation effect of food.

As an application example therein, as shown in FIG. 22 and FIG. 23, the case 1 is provided with second air control devices 6, where the second air control devices 6 are in one-to-one correspondence with the inner chambers 20, and the second air control devices 6 each include a mounting frame 61, a plurality of air guide plates 62 movably provided on the mounting frame 61, and a second driver 63 configured to drive the air guide plates 62 to oscillate; and the air guide plates 62 are provided between the air blower 41 and the inner chamber 20.

In some embodiments, each of the air guide plates 62 is rotatably mounted on the mounting frame 61, the second driver 63 is configured as a second motor, and the second motor is in transmission connection with the air guide plates 62. By controlling operation of the second motor, an oscillation angle of the air guide plates 62 can be controlled, so that the uniformity of air supply of the air blower 41 can be improved by the air guide plates 62.

In some embodiments, as shown in FIG. 23, each of the air guide plates 62 is provided with a first gear 621 at an end portion, and the first gears 621 on different air guide plates 62 are in transmission connection through a chain, so that when one of the air guide plates 62 rotates, the other air guide plates 62 also rotate therewith.

In some embodiments, the first gears 621 on different air guide plates 62 are in transmission connection through a gear rack.

In some embodiments, one of the air guide plates 62 is provided with a second gear 622 at an end portion, and the second motor is meshed with the second gear 622, so that one of the air guide plates 62 is driven by the second motor to rotate, and further the other air guide plates 62 are driven to rotate.

As an application example therein, as shown in FIG. 10, the barrier structure 3 is a vacuum space 32.

In some embodiments, after the two adjacent side wall members 21 are provided at intervals, a periphery of the air layer 31 formed between the two adjacent side wall members 21 is sealed, and an air suction operation is performed on the sealed air layer 31, so that the vacuum space 32 is formed between the two side wall members 21. By forming the vacuum space 32, the heat insulation performance can be further improved.

As an application example therein, as shown in FIG. 11, the barrier structure 3 is filled therein with a heat insulation filler 33.

In some embodiments, a heat insulation filler 33 is filled in the air layer 31 formed between the two adjacent side wall members 21, so that by filling the provided heat insulation filler 33, the heat transmission between the two side wall members 21 can be reduced.

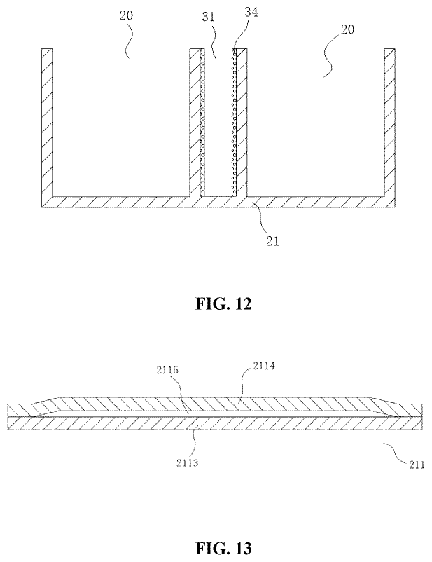

In some embodiments, as shown in FIG. 12, two inner side surfaces of the air layer 31 are each coated with a heat insulation coating layer 34, so as to reduce the heat transmission between the two side wall members 21.

As an application example therein, as shown in FIG. 1 and FIG. 25, the case 1 is provided with a lifting groove 164 on a side surface.

In some embodiments, both left and right side surfaces of the case 1 are provided with the lifting groove 164, so that by providing the lifting grooves 164, a holding effect of carrying the dryer by a person when carrying the dryer can be improved, thus improving reliability and security of a carrying operation.

As an application example therein, as shown in FIG. 2, the case 1 is provided with a plug receiving groove 182, and the plug receiving groove 182 is provided therein with a socket structure for plugging a plug.

In some embodiments, the plug receiving groove 182 is provided to be recessed in the bottom side plate 18 of the case 1. By providing the plug receiving groove 182 on the bottom side plate 18 of the case 1, influence of providing the plug receiving groove 182 on appearance of the dryer can be reduced.

As an application example therein, as shown in FIG. 24, the case 1 is provided with a dustproof cover 7 on a rear side.

In some embodiments, in order to facilitate circulation of airflow, several air holes 101 are provided on a rear side plate of the case 1, and the dustproof cover 7 is provided outside the several air holes 101, so as to avoid accidental entry of external debris into the case 1 to affect application of the air supply assemblies 4, and improve application safety.

In some embodiments, the dustproof cover 7 includes a cover body 71, where the cover body 71 is configured to be installed on the case 1, the cover body 71 is provided with a plurality of hollow areas 72, and a gauze is provided in the hollow areas 72.

As an application example therein, as shown in FIG. 1 and FIG. 25, the case 1 is provided with cabinet doors 8, and the number of the cabinet doors 8 is in correspondence with the number of the inner chambers 20; or the at least two inner chambers 20 share one cabinet door 8.

In some embodiments, the number of the cabinet doors 8 is set to be in correspondence with the number of the inner chambers, so that use of a specific one of the inner chambers 20 can be independently controlled in use.

In some embodiments, a plurality of the inner chambers 20 can also be provided to share one cabinet door 8, which is not specifically limited herein.

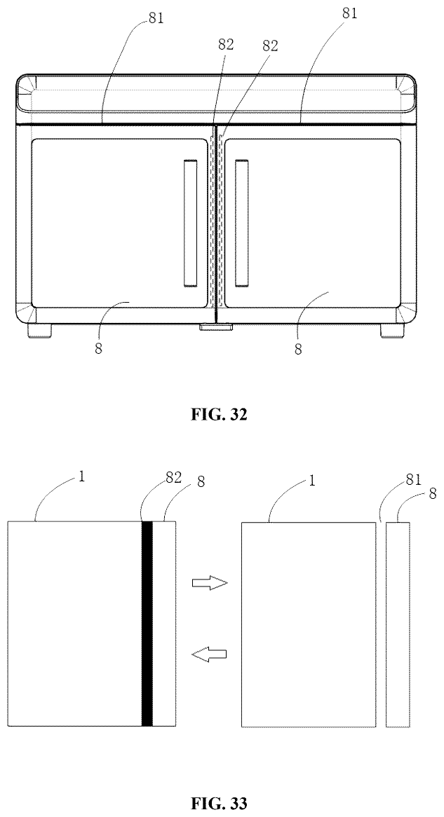

As an application example therein, as shown in FIG. 32 and FIG. 33, the inner chambers 20 and the cabinet doors 8 are provided with vent gaps 81 therebetween, and air delivered by the air supply assemblies 4 to the inner chambers 20 is discharged to the outside from the vent gaps 81; and
the vent gaps 81 of the two adjacent inner chambers 20 are provided to be sealed and blocked from each other.

In some embodiments, the cabinet doors 8 each can be provided with a sealing separator 82 on one or more edges. When the cabinet door 8 is closed on the inner chamber 20, the sealing separator 82 is clamped between an edge of the inner chamber 20 and the edge of the cabinet door 8, so that multiple edges of the inner chamber 20 and the cabinet door 8, except edges where the sealing separator 82 is located, cannot be completely attached, so as to form the vent gap 81.

In some embodiments, the seal separator 82 is provided on one or more edges of the inner chambers 20.

In some embodiments, a solution in which the two inner chambers 20 are provided is taken as an example for description, in which case the two inner chambers 20 are correspondingly provided with the cabinet door 8, respectively. In the above, when the two inner chambers 20 are provided side by side on the left and right, door shafts of the two cabinet doors 8 are respectively provided on left and right edges of the case 1, in which case the sealing separators 82 are provided between the two inner chambers 20 on the left and right, as shown in FIG. 32. When the two inner chambers 20 are provided to be vertically stacked, the door shafts of the two cabinet doors 8 can be provided on the same side edge of the case 1, and can also be provided on left and right edges of the case 1, respectively, in which case the sealing separators 82 are provided between the upper and lower inner chambers 20.

In some embodiments, the sealing separators 82 are provided as sealing strips, and can play a role in shock absorption, water resistance, sound insulation, heat insulation, dust prevention, and the like. It can be understood that, the sealing strips can be made from a material such as rubber, plastic, paper, and a metal material.

By providing the vent gaps 81, each of the inner chambers 20 can be provided with an independent air circulation channel, and respective independent drying effect is better. By providing the sealing separators 82, different inner chambers 20 can be blocked at an output end of airflow, so as to avoid interference between airflows output from the adjacent inner chambers 20, and the phenomenon of influenced temperature and odor between the two inner chambers 20 can also be avoided, thus improving users' using experience.

As an application example therein, a ratio of a flow area of the vent gap 81 to a volume of the inner chamber 20 is:
1 mm²: 10400 mm³-1 mm²: 5200 mm³.

In some embodiments, the ratio of the flow area of the vent gap 81 to the volume of the inner chamber 20 is: 1 mm²: 7800 mm³

In some embodiments, the flow area of the vent gap 81 can be understood as: in a closed state between the cabinet door 8 and the inner chamber 20, except the edge where the sealing separator 82 is located, a product of length of the other edges multiplied by a spacing distance between the cabinet door 8 and the inner chamber 20.

In some embodiments, values of the spacing distance between the cabinet door 8 and the inner chamber 20 include a maximum distance, a minimum distance, and an average distance therebetween.

By designing numerical values of the flow area of the vent gap 81 and the volume of the inner chamber 20, it can facilitate controlling a vent volume of the inner chamber 20 when performing drying, so as to achieve a better temperature control effect, and can improve a flavor effect of food prepared by drying the food.

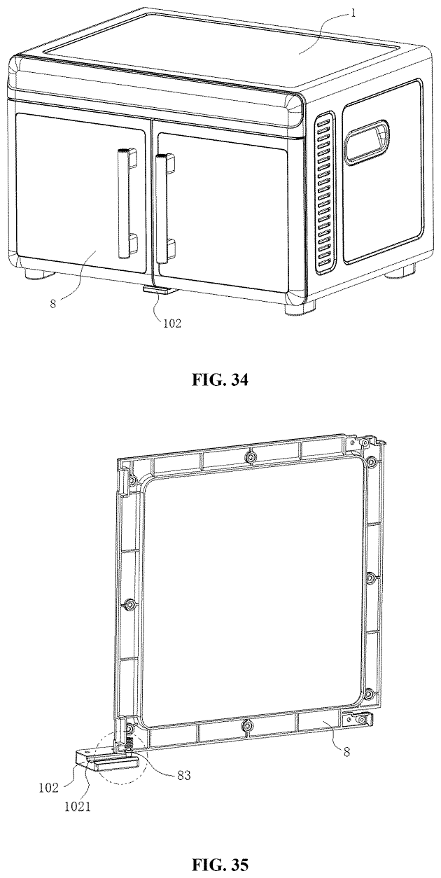

As an application example therein, as shown in FIG. 34 to FIG. 37, the case 1 is provided with a bearing portion 102, the cabinet doors 8 are each provided with an abutment portion, and the abutment portion can move to the bearing portion 102 with closing of the cabinet door 8, so as to support the cabinet door 8 through the bearing portion 102; and
the bearing portion 102 is provided with a first fitting portion, the cabinet door 8 is provided with a second fitting portion, and the second fitting portion can form a locking connection with the first fitting portion along with the closing of the cabinet door 8.

In some embodiments, the bearing portion 102 is provided in the bottom portion of the case 1, and the abutment portion is a bottom end surface of the cabinet door 8.

In some embodiments, the first fitting portion and the second fitting portion are engaged with each other so as to form the locking connection. A mode of engagement herein includes, but is not limited to, an engagement relationship formed by plug fitting between a pin and a slot.

In some embodiments, the first fitting portion and the second fitting portion are adsorbed to each other so as to form the locking connection, for example, the first fitting portion and the second fitting portion are provided in a form of magnetic attraction.

By providing the bearing portion 102, the cabinet door 8 can be supported at least in a closed state, so as to reduce application fatigue and wear at a joint between the cabinet door 8 and the case 1, prolong service lifetime of the joint between the cabinet door 8 and the case 1, and avoid a phenomenon of premature corner lowering or drooping of the cabinet door 8 in use.

By providing the first fitting portion and the second fitting portion, stability of the cabinet door 8 in a closed state can be improved, and accidental disengagement of the cabinet door 8 from the support of the bearing portion 102 can be avoided, so that the user can have better using experience.

As an application example therein, as shown in FIG. 34, one end of the bearing portion 102 is connected to the case 1, and the other end is provided to protrude towards a front side surface of the case 1; and
the bearing portion 102 is detachably connected to the case 1; or the bearing portion 102 is integrated with the case 1.

In some embodiments, the bearing portion 102 and the case 1 are detachably connected, for example, the bearing portion 102 is mounted and fixed on the case 1 by a fastener such as a bolt.

In some embodiments, the bearing portion 102 is integrated with the case 1; for example, the bearing portion 102 is fixed on the case 1 by welding; and for another example, the bearing portion 102 and the front side surface of the case 1 are formed by stamping.

By providing the bearing portion 102 in a form of protruding towards the front side surface of the case 1, it can be better fitted with an application state of the cabinet door 8 on the case 1, so that the cabinet door 8 can be supported and borne by the bearing portion 102.

As an application example therein, as shown in FIG. 35 to FIG. 37, the first fitting portion is a locking slot 1021 provided on the bearing portion 102, the second fitting portion is a locking pin 83 provided on the cabinet door 8, and the locking pin 83 can be moved to extend into the locking slot 1021.

As an application example therein, the first fitting portion is a locking pin 83 provided on the bearing portion 102, the second fitting portion is a locking slot 1021 provided on the cabinet door 8, and the locking pin 83 can be moved to extend into the locking slot 1021.

Through the engagement connection between the locking pin 83 and the locking slot 1021, a locking state of the cabinet door 8 after being closed can be conveniently maintained, thus avoiding detachment of the cabinet door 8 from the support of the bearing portion 102 caused by accidental touch, and facilitating improving the reliability of the dryer in use.

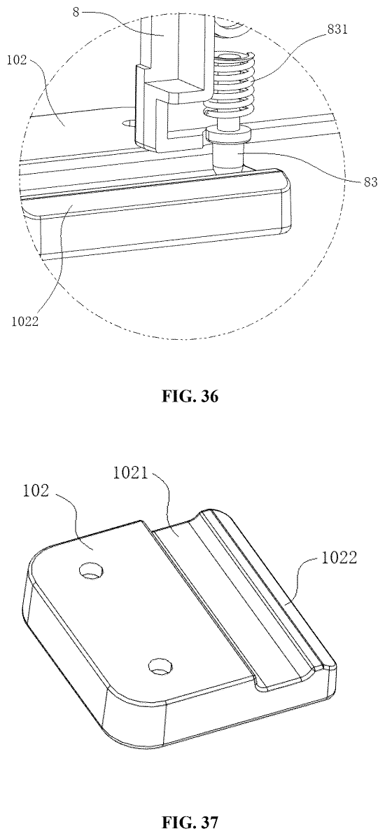

As an application example therein, as shown in FIG. 36, the locking pin 83 is provided with an elastic element 831, and the elastic element 831 is connected to the locking pin 83, and is configured to provide a pre-tightening force to the locking pin 83.

In some embodiments, a tail end of the locking pin 83 is provided to extend out of the cabinet door 8, a body of the locking pin 83 is slidably provided in the cabinet door 8, and the elastic element 831 is connected to the body of the locking pin 83 and provided inside the cabinet door 8, as shown in FIG. 36.

In some embodiments, the elastic element 831 is a spring, and the spring is sleeved on the body of the locking pin 83.

By providing the elastic element 831, a certain pre-tightening force can be provided to the locking pin 83, so that the locking pin 83 can have a function of automatic reset, so that flexibility of the locking pin 83 in use is improved, and reliability of engagement between the locking pin 83 and the locking slot 1021 can be enhanced.

As an application example therein, as shown in FIG. 36 and FIG. 37, the tail end of the locking pin 83 is provided in a spherical shape, and an inner wall surface of the locking slot 1021 is provided as a cambered surface; and/or a front end of the bearing portion 102 is provided with an inclined guide surface 1022.

In some embodiments, the body of the locking pin 83 is provided as a cylinder, and the tail end of the locking pin 83 is provided in a spherical shape, so that through cooperation with the use of the elastic element 831, smoothness of contact between the locking pin 83 and the bearing portion 102 can be improved.

In some embodiments, at least one inner wall surface of the locking slot 1021 is provided as a cambered surface, and the cambered surface is located in a detachment direction of the locking pin 83. When the cabinet door 8 is opened from a closed state, the spherical tail end of the locking pin 83 is in contact with the cambered surface of the locking slot 1021, in which case a force required for the user to open the cabinet door 8 can be reduced.

By designing the shape of the tail end of the locking pin 83 and the inner wall surface of the locking slot 1021, the user can conveniently open the cabinet door 8.

In some embodiments, the inclined guide surface 1022 is provided on a top end surface of the bearing portion 102, and a lower end of the inclined guide surface 1022 is connected to a front side surface of the bearing portion 102.

By providing the inclined guide surface 1022, a certain guiding effect can be achieved when closing the cabinet door 8, thus improving smoothness of the cabinet door 8 in a closing operation.

Compared with the prior art, the technical solutions of the embodiments of the present disclosure at least have the following beneficial effects.

In the solutions of the embodiments, by forming the barrier structure 3 between the side wall members 21 of two inner tanks, the inner chambers 20 of the two inner tanks 2 can be blocked by the barrier structure 3, so that heat transmission between the two adjacent inner chambers 20 can be reduced, the influence of influenced temperature and tainted odor between different inner chambers 20 can be reduced and even avoided, and independence of processing food between different inner chambers 20 can be improved, so that users can have better using experience.

Finally, it should be noted that various embodiments above are merely used for illustrating the technical solutions of the present disclosure, rather than limiting the present disclosure. While the detailed description is made to the present disclosure with reference to various preceding embodiments, those ordinarily skilled in the art should understand that they still could modify the technical solutions described in the various preceding embodiments, or make equivalent substitutions to some or all of the technical features therein. These modifications or substitutions do not make essence of corresponding technical solutions depart from the scope of the technical solutions of various embodiments of the present disclosure, and they should be covered within the scope of the claims and the description of the present disclosure. Particularly, various technical features mentioned in various embodiments can be combined in any form as long as there is no structural conflict. The present disclosure is not restricted to specific embodiments disclosed herein, but covers all technical solutions falling within the scope of the claims.

1. A dryer, comprising:
a case;
at least two inner tanks, wherein the at least two inner tanks each comprise a side wall member formed by sequentially connecting at least two side plates into one piece, the at least two inner tanks are each provided with an inner chamber; the two inner tanks are provided side by side or stacked in the case, and the side wall members of the two inner tanks are provided at intervals so as to form a barrier structure, wherein the barrier structure is configured to block heat between the inner chambers of the two inner tanks; and
air supply assemblies, provided in the case and being in one-to-one correspondence with the inner chambers, wherein the air supply assemblies each have an air supply end directed to the inner chambers.

2. The dryer according to claim 1, wherein two side plates are provided, and the side wall members have a cross section in an “L” shape; or
three side plates are provided, and the side wall members have a cross section in a “U” shape; or
four side plates are provided, and the side wall members have a cross section in a rectangular shape.

3. The dryer according to claim 2, wherein the side wall member is molded as an integrated structure; or
two adjacent side plates on the side wall member are spliced, and the two adjacent side plates are sealed at a joint therebetween.

4. The dryer according to claim 3, wherein the side plates comprise a first side plate and a second side plate, wherein the first side plate and the second side plate are respectively provided at two sides of the inner chamber; and
the first side plate and the second side plate are provided with a plurality of convex ribs protruding towards the inner chambers, the plurality of convex ribs are provided at intervals in a vertical direction, and the convex ribs on the first side plate and the second side plate are corresponding to each other.

5. The dryer according to claim 1, wherein the side plates comprise an inner side plate and an outer side plate, and a hollow interlayer is provided between the inner side plate and the outer side plate.

6. The dryer according to claim 5, wherein the inner side plate and the outer side plate have different thermal conductivity coefficients.

7. The dryer according to claim 1, wherein the barrier structure is an air layer; and
the case comprises an outer shell, wherein the outer shell is provided with a plurality of vent holes, a flow space is formed between the outer shell and the inner tanks, and the flow space communicates the air layer with the vent holes.

8. The dryer according to claim 7, wherein the vent holes are provided in a strip shape, and the plurality of vent holes are provided side by side on a side surface of the outer shell in a vertical direction.

9. The dryer according to claim 8, wherein the case comprises an upper cover plate, the side wall members have a cross section in a “U” shape, and U-shaped openings of the two side wall members are directed to the upper cover plate and are hermetically connected to the upper cover plate; and
the upper cover plate is provided with a first through hole communicating with the air layer.

10. The dryer according to claim 9, wherein a sealing rubber strip is provided between the side wall members and the upper cover plate; and
the sealing rubber strip has a width corresponding to a thickness of the side plates; or the sealing rubber strip has a width corresponding to a width of the barrier structure, the sealing rubber strip is provided with a second through hole, and the second through hole is corresponding to the first through hole.

11. The dryer according to claim 8, wherein the case comprises a rear cover plate, a rear end of the side wall members is hermetically connected to the rear cover plate; and
the rear cover plate is provided with a third through hole communicating with the air layer.

12. The dryer according to claim 7, wherein the case is provided therein with a discharge-promoting fan, wherein an air supply end of the discharge-promoting fan is provided towards the air layer; and
airflow enters the air layer under an action of the discharge-promoting fan, passes through the flow space and then is discharged from the vent holes.

13. The dryer according to claim 12, wherein at least one barrier net is provided between the side wall members and the rear cover plate; and
the side wall members and the barrier net are hermetically connected at a joint therebetween, and the rear cover plate and the barrier net are hermetically connected at a joint therebetween.

14. The dryer according to claim 13, wherein the rear cover plate is provided thereon with air guide structures in a horn shape corresponding to the air supply assemblies.

15. The dryer according to claim 14, wherein a mesh density of the barrier net is uniformly arranged; or
a mesh density of the barrier net is decreased from a central area of the inner chambers to an outer edge.

16. The dryer according to claim 1, wherein the air supply assemblies each comprise an air blower and an electric heating member, wherein the air blower is configured to transfer heat dissipated by the electric heating member into the inner chambers.

17. The dryer according to claim 1, wherein the case is provided with cabinet doors, and the number of the cabinet doors is in correspondence with the number of the inner chambers; or
the at least two inner chambers share one cabinet door.

18. The dryer according to claim 17, wherein the inner chambers and the cabinet doors are provided with vent gaps therebetween, and air delivered by the air supply assemblies to the inner chambers is discharged to the outside from the vent gaps; and
the vent gaps of the two adjacent inner chambers are provided to be sealed and blocked from each other.

19. The dryer according to claim 18, wherein a ratio of a flow area of the vent gap to a volume of the inner chamber is: 1 mm²: 10400 mm³-1 mm²: 5200 mm³.

20. The dryer according to claim 17, wherein the case is provided with a bearing portion, the cabinet doors are provided with an abutment portion, and the abutment portion can move to the bearing portion with closing of the cabinet doors, so as to support the cabinet doors through the bearing portion; and
the bearing portion is provided with a first fitting portion, the cabinet door is provided with a second fitting portion, and the second fitting portion can form a locking connection with the first fitting portion along with the closing of the cabinet doors.
